(19) United States
(12) Patent Application Publication
(10) Pub. No.: US 2018/0049590 A1
(43) Pub. Date: Feb. 22, 2018

(54) DEVICES AND METHODS FOR SUPPORTING AND PREPARING FOODS

(71) Applicants: Alan BACKUS, Los Angeles, CA (US); Marici IULIUS, Las Vegas, NV (US)

(72) Inventors: Alan BACKUS, Los Angeles, CA (US); Marici IULIUS, Las Vegas, NV (US)

(21) Appl. No.: 15/297,788

(22) Filed: Oct. 19, 2016

Related U.S. Application Data
(63) Continuation-in-part of application No. 15/142,072, filed on Apr. 29, 2016.

(51) Int. Cl. A47J 37/12

(52) U.S. Cl. CPC A47J 37/129; A47J 37/1261; A47J 37/128; A47J 37/1285

(57) ABSTRACT

Reduced cooking liquid usage deep fryers, particularly adapted to cooking fowl, as well as other articles. Cooking liquid storage and filtering apparatus. Heating element structure configured to reduce the overall height of a deep fryer. Food support apparatus which simplify food handling. Cooking vessel configurations configured to reduce cooking liquid usage. Volume displacement members which may reduce cooking liquid usage. Fry basket construction. Food support and containment structures. Cooking liquid overflow safety structures. Passive condensation exhaust filtering. Apparatus allowing the cooking of stuffing and/or other articles, while deep frying a fowl or other articles. Removable dual food support handles. Food support apparatus for deep fryers which deep fry only a portion of unitary food article at one time.

### TECHNICAL FIELD

The present application is a continuation in part of U.S. patent application Ser. No. 15/258,453.

### BACKGROUND

Deep fryers generally utilize substantial quantities cooking oils. These oils typically are expensive. Also, these oils may present storage and disposal problems. Additionally, the more there are of these oils, the more difficult they may be to handle. Examples shown herein, among other advantages, may reduce the amount of cooking oils utilized in deep frying articles. Such examples may also show how to more easily store and handle deep fryer cooking oil.

### BRIEF DESCRIPTION OF THE DRAWINGS

Various embodiments will become better understood with regard to the following description, appended claims and accompanying drawings wherein:

FIG. 1 is a perspective of embodiment 601.

FIG. 2 is a perspective of embodiment 601, with outer enclosure 604 removed.

FIG. 3 is a perspective of embodiment 601, with outer enclosure 604 and cooking vessel 606 removed.

FIG. 4 is a perspective of embodiment 601, with outer enclosure 604, cooking vessel 606, control box/heat coil 608, and lid 610 removed.

FIG. 5 is a exploded perspective of embodiment 601.

FIG. 6 is a perspective of embodiment 601, including also: oil storage container 612, filter media support 616, and oil storage container lid 618, in their assembled storage condition.

FIG. 7 is an exploded perspective view of embodiment 601, including also: oil storage container 612, filter media 614, filter media support 616, and oil storage container lid 618, in their assembled storage condition.

FIG. 8 is an exploded perspective view of: oil storage container 612, filter media 614, filter media support 616, and oil storage container lid 618, in their oil storage condition.

FIG. 9 is a perspective of embodiment 601, in its draining condition.

FIG. 10 is an exploded perspective of food support 620, including: left food support dynamic side wall 622, right food support dynamic side wall 624, left food support handle 626, right food support handle 628. In addition, FIG. 10 shows wire basket 630, and wire basket lid 632.

FIG. 11 is a perspective view of food support 620, with wire basket 630 mounted within it, and wire basket lid 632 mounted within wire basket 630, as a nonlimiting and nonexhaustive example, during cooking, or at other times.

FIG. 12 is a perspective of a first example 634 of wire basket lid 632, mounted within wire basket 630.

FIG. 13 is a perspective of a second example 635 of wire basket lid 632, mounted within wire basket 630.

FIG. 14 is an exploded perspective of food support 620, including lid 610.

FIG. 14A is a detail of FIG. 14, as indicated in FIG. 14.

FIG. 15 is a front view of food support 620, including lid 610, article 634, displacement/cooking chamber 636, chamber plug 638.

FIG. 16 is a front view taken from the same point as FIG. 15, and showing most of the same elements, but with displacement/cooking chamber 636 penetrating inside of article 634.

FIG. 17 is identical to FIG. 16, except article 634 with inserted displacement/cooking chamber 636, is lowered into food support 620.

FIG. 18 is identical to FIG. 17, except lid 630 is mounted on to the tops of left food support handle 626 and right food support handle 628.

FIG. 19 is a perspective of embodiment 601, showing the section plane of FIG. 20.

FIG. 20 is a section view of FIG. 19, as indicated in FIG. 19.

FIG. 21 is a perspective of embodiment 601, showing the section plane of FIG. 22.

FIG. 22 is a section view of FIG. 21, as indicated in FIG. 21.

FIG. 23 is an exploded perspective of displacement/cooking chamber 636 and chamber plug 638.

FIG. 24 is a perspective of cooking vessel 606.

FIG. 25 is a detail perspective of FIG. 26, as indicated in FIG. 26.

FIG. 26 is a perspective of food support 620, with left food support handle 626 position to be mounted within bracket 714.

FIG. 27 a perspective taken from the same viewpoint as FIG. 26, with left food support handle 626 mounted within bracket 714.

FIG. 28 is a perspective of embodiment 716, with domed lid 718 inverted, as a nonlimiting and nonexhaustive example, to make embodiment 716 more compact for shipment, storage, or other purposes.

FIG. 29 is a perspective taken from the same viewpoint as FIG. 28, with domed lid 718 upright, as it might be positioned during cooking, or at other times.

FIG. 30 is a perspective taken from the same viewpoint as FIG. 29, but including article to be cooked 730, and including domed lid 718 and outer enclosure 728 being removed.

FIG. 31 is a perspective taken from the same viewpoint as FIG. 30, but further including cooking vessel 726 being removed.

FIG. 32 is a perspective taken from the same viewpoint as FIG. 29, and with FIG. 32 indicating where the section view of FIG. 33 was taken.

FIG. 33 is a section view of embodiment 716, as indicated in FIG. 32.

FIG. 34 is a perspective exploded view of embodiment 716.

### DETAILED DESCRIPTION

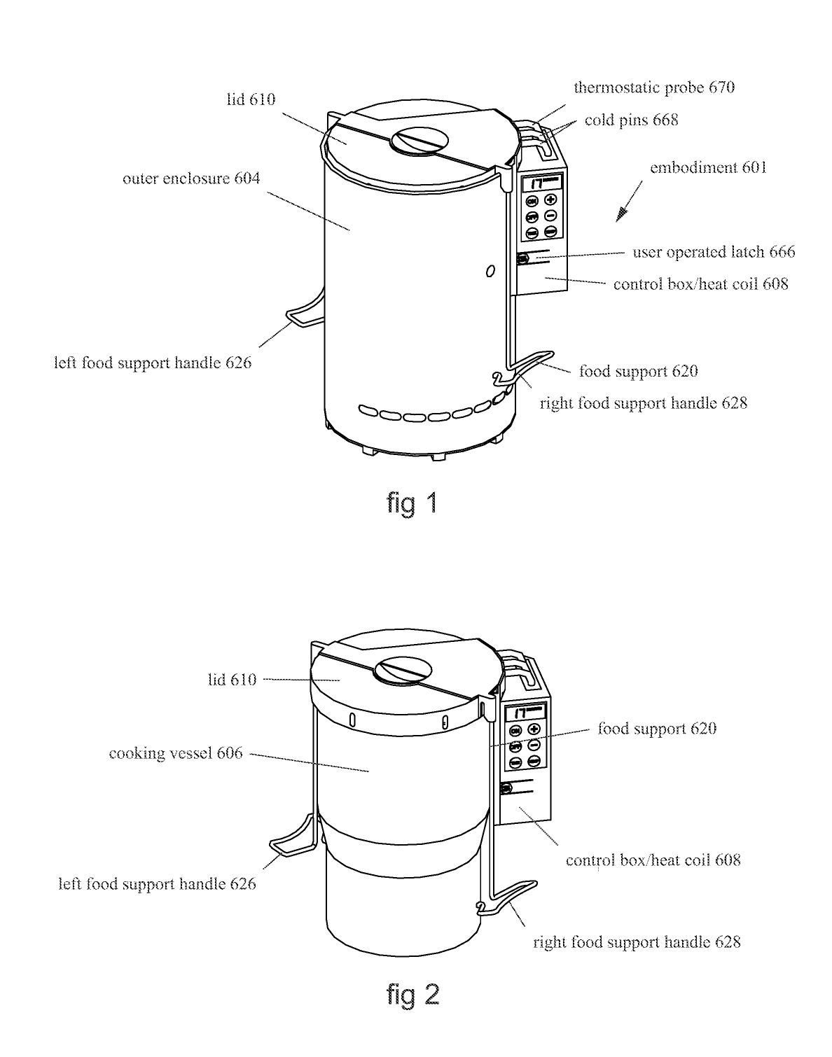

Detailed Description—Embodiment 601—FIGS. 1 through 27:

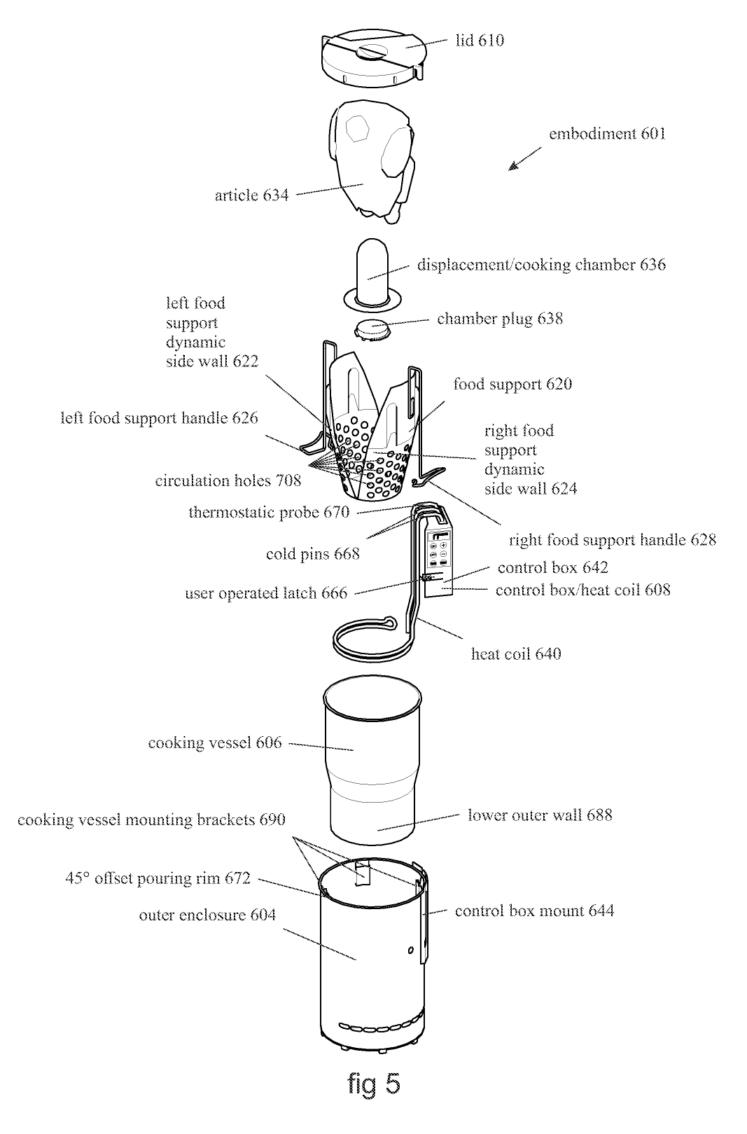

Referring especially to FIG. 5, as well as other drawings herein, embodiment 601 generally comprises: lid 610, displacement/cooking chamber 636, (optionally) chamber plug 638, food support 620, control box/heat coil 608, cooking vessel 606 and outer enclosure 604.

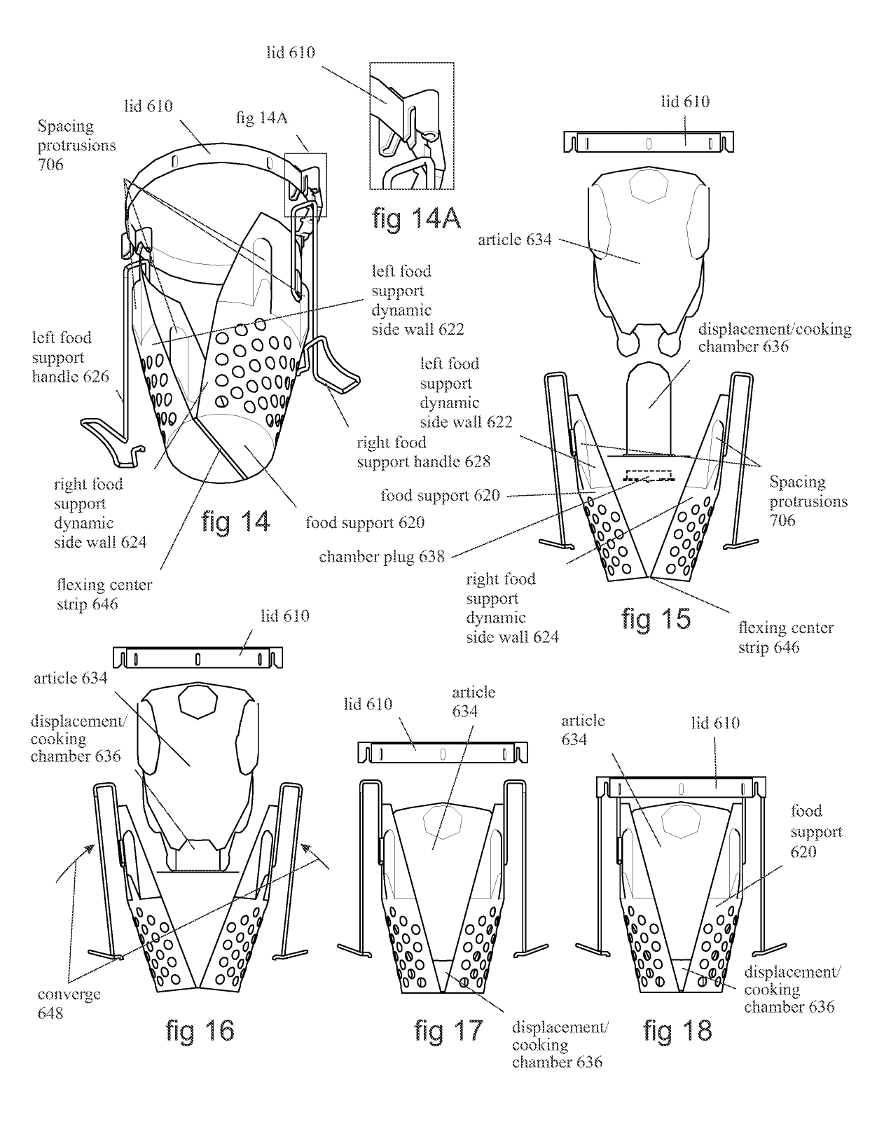

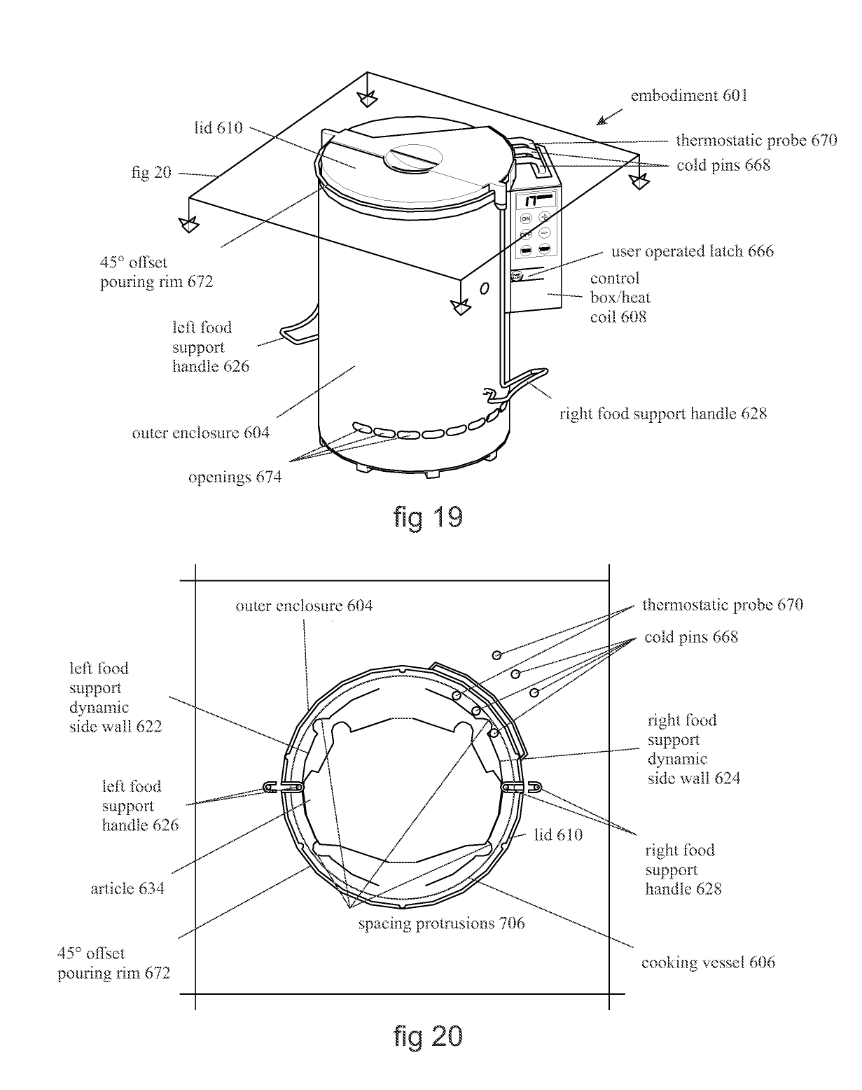

Using embodiment 601 may be done, as a nonlimiting and nonexhaustive example, utilizing the following steps:
1) Placing outer enclosure 604 on a horizontal support surface.
2) Placing cooking vessel 606 within outer enclosure 604.
3) Dropping heat coil 640 into cooking vessel 608, and mounting rigidly attached control box 642 to control box mount 644, which is disposed on the upper portion of right rear side of enclosure 604.
4) Placing a predetermined amount of cooking oil into cooking vessel 606, and adjusting controls on control box 642 to activate heat coil 640, and thus heat up the cooking oil to cooking temperatures
5) Optionally, placing items to be cooked, as a nonlimiting and nonexhaustive example stuffing, into displacement/cooking chamber 636, and capping displacement/cooking chamber 636 with chamber plug 636. Embodiment 601 may be used without chamber plug 636 when not cooking items within displacement/cooking chamber 636.
6) Optionally, and including where article 634 is a fowl , placing displacement/cooking chamber 636 inside the empty gut cavity of article 634, which is shown as a fowl (transition from FIG. 15 to FIG. 16). When displacement/cooking chamber 636 is placed inside the gut cavity of article 634, it may support article 634 in an upright position. It may also serve as a carving stand when resting on a horizontal support surface. When you
7) Dropping the above assemblage into food support 620, which, because of the base of displacement/cooking chamber 636 resting and putting downward pressure on flexing center strip 646, causes left food support dynamic side wall 622, and right food support dynamic side wall 624 to converge 648 toward one another and contain article 634 (transition from FIGS. 16 to 17).
8) Mounting lid 610 on the upper portions of left food support handle 626 and right support handle 624 (FIGS. 14, 14A, and transition from FIG. 17 to FIG. 18).
9) Lowering the entire above assemblage into cooking vessel 606, and leaving it there long enough for cooking to occur (transition from FIG. 18 to FIG. 19).
10) After cooking, raising the entire assemblage out of cooking vessel 606 and removing article 634 from food support 620. Optionally, pulling out chamber plug 638 from displacement/cooking chamber 636 and removing the, now cooked, contents. Serving article 634, optionally using displacement/cooking chamber 636 as a vertical carving stand.

Right food support dynamic side wall 624 and left food support dynamic side wall 622, may be converge 648 to a generally vertical disposition, as shown in FIGS. 17 and 18, when lid 610 is affixed to the upper ends of both left food support handle 626 and right food support handle 628.

Independent of this, right food support dynamic side wall 624 and left food support dynamic side wall 622, may converge 648 simply by the camming action between the outer surfaces of right food support dynamic side wall 624 and left food support dynamic side wall 622, and upper rim 664 of cooking vessel 606 as food support 620 is lowered into cooking vessel 606. Particularly where large foods are involved, such as, by way of a nonlimiting and nonexhaustive example, a large Thanksgiving day size turkey. This forceful converging 648 camming action may help provide the compressive forces to place such a large food within the narrow confines of cooking vessel 606.

Right food support dynamic side wall 624 and left food support dynamic side wall 622, may be fabricated utilizing any suitable construction. As both a nonlimiting and non-exhaustive example, each may be stamped in aluminum and have a non-stick inner surface to help with easy cleaning, and the easy release and removal of article 634 (such as the fowl illustrated) from food support 620.

Flexing center strip 646, as a nonlimiting and nonexhaustive example, may be fabricated from resilient aluminum which is biased to the disposition shown in FIGS. 15 and 16, and is riveted to left food support dynamic side wall 622 and right food support dynamic side wall 624.

As an alternative to this construction, flexing center strip may be biased inward so that left food support dynamic side wall 622 and right food support dynamic side wall 624 must be parted to allow the insertion of article 634.

As yet another alternative, a common hinge with limited travel, which is either not biased or biased inward or outward, utilizing an auxiliary spring, might be used for center strip 646.

As yet another alternative flexing center strip 646 might be rigid, not allowing movement of support dynamic side wall 622 and right food support dynamic side wall 624.

As one further alternative, food support 620 might be constructed as a unitary piece, with or without a V-shaped gap between left food support dynamic side wall 622 and right food support dynamic side wall 624.

As yet one further alternative, food support 620 might be constructed as a tapered or an un-tapered unitary bucket, with or without a nonstick coating on its interior.

Spacing protrusions 706 (FIGS. 14 and 15) on the exterior surfaces of dynamic side walls 622 and 624, are configured to create a minimum predetermined space between the exterior surfaces of dynamic side walls 622 and 624, and the interior surfaces of cooking vessel 606. This at least allows the circulation of hot liquid, so that dynamic side walls 622 and 624 may be at virtually the same temperature as the hot liquid within cooking vessel 606. This, in combination with circulation holes 708 (FIG. 5), and nonstick surfaces on surfaces which touch and/or don't touch articles being cooked 634, may help achieve even browning of articles 634 being cooked.

All of the above constructions might benefit from nonstick coatings on any portions which make and/or don't make contact with article 634. This is at least both because it may help even browning, as mentioned above, and because ease of cleaning may be enhanced.

As both a nonlimiting and nonexhaustive example, displacement/cooking chamber 636, might be drawn in aluminum and might also be nonstick coded at lease for easy cleaning and/or for other reasons.

Chamber plug 638, as both a nonlimiting and nonexhaustive example, might be injection molded from silicone rubber, or other food safe, high temperature elastomers, or from other suitable materials.

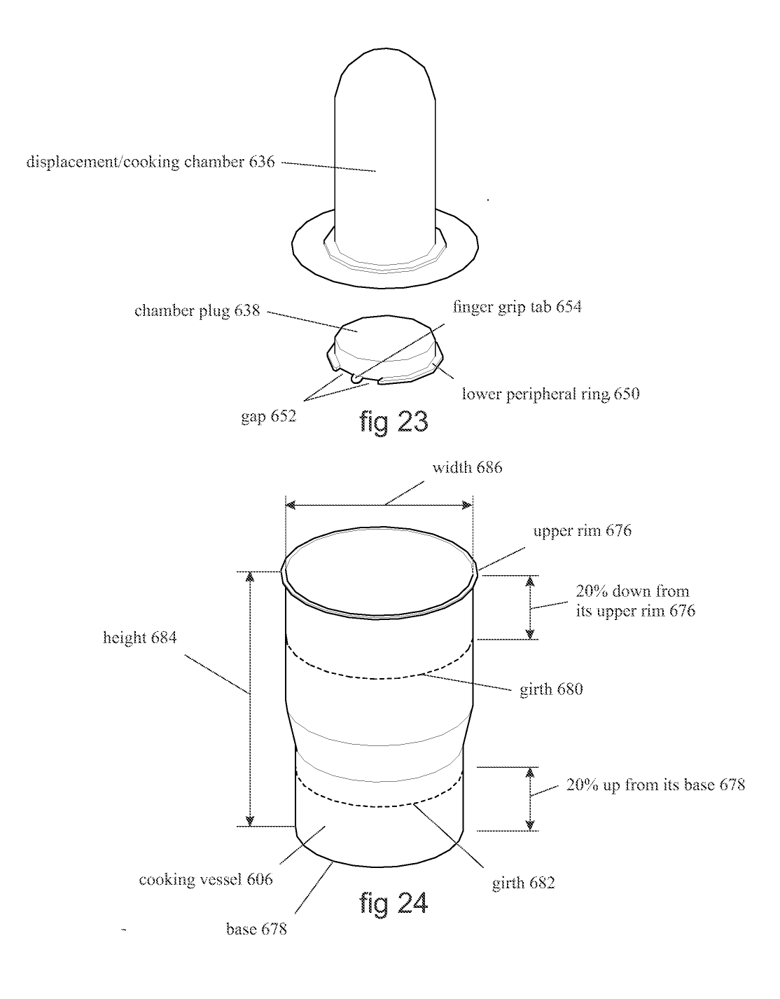

Referring to FIG. 23, chamber plug 638 has lower peripheral ring 650, which is integral and reinforces most of the lower edge of chamber plug 638, except where it is interrupted by gap 652. Gap 652 allows pressure within displacement/cooking chamber 636 to be released in a one-way, outward fashion, and also prevents cooking oil from entering into displacement/cooking chamber 636, when pressure is lowered within displacement/cooking chamber 636 as during cooling or at other times.

Finger grip tab 654 may be pulled by the user to release vacuum within displacement/cooking chamber 636 to make it easier to remove chamber plug 638, or for other reasons. Finger grip tab 654 may also aid in pulling chamber plug 638 out from the base of displacement/cooking chamber 636.

As nonlimiting and non-exhaustive alternatives to the above construction for displacement/cooking chamber 636, it may be constructed from wires, like a round top birdcage, or from perforated metal, or be solid, without an interior cavity, or may be a permanently sealed container, like a sealed tin can filled with air, oil, or other suitable material, or may be of other desirable construction.

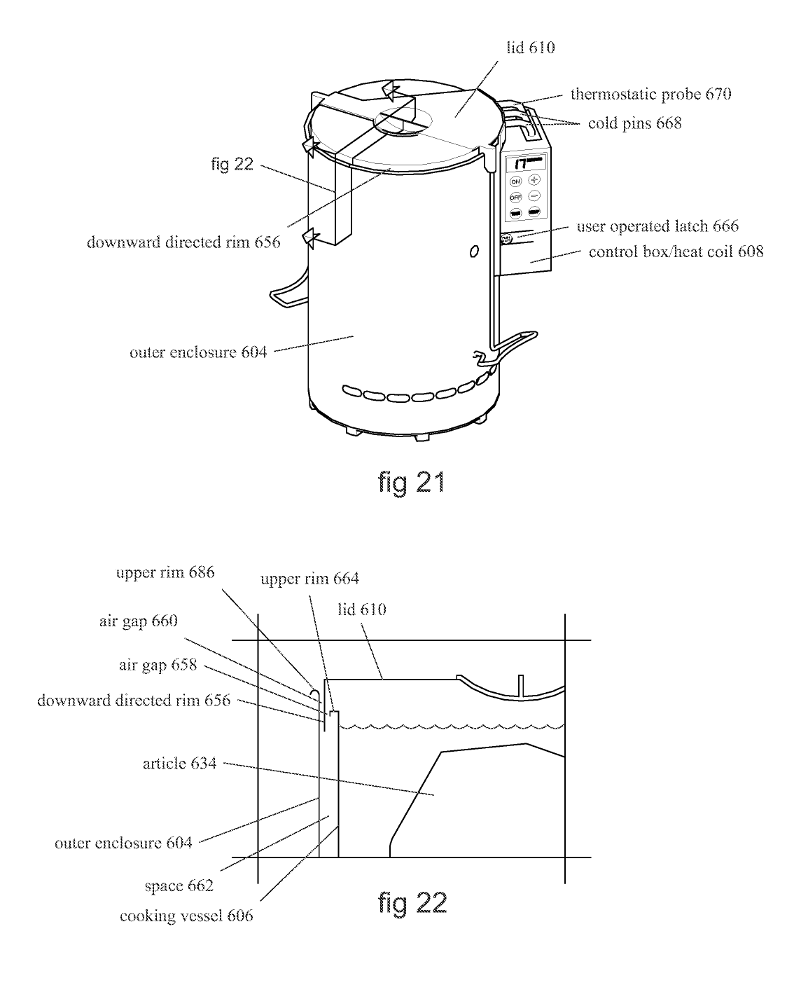

As best shown in FIGS. 21 and 22, as well as other figures herein, when lid 610 is mounted during cooking, or at other times, it's annular peripheral downward directed rim 656 is spaced between the upper rim 686 of outer enclosure 604 and the upper rim 664 of cooking vessel 606, with annular air gap 658 between downward directed rim 656 and upper rim 664 of cooking vessel 606, and annular air gap 660 between peripheral downward directed rim 656 and the upper portion of outer enclosure 604.

This arrangement helps direct steam and debris downward into space 662 formed between the outer walls of cooking vessel 606 and the inner walls of outer enclosure 604. By doing this, steam may be condensed and cooled before exiting embodiment 601.

This may help condense and trap debris before it enters the immediate environment surrounding embodiment 601. This in turn may help reduce odors and greasy kitchen surfaces normally associated with frying.

Further, should foam and/or hot bubbles and/or hot oil and/or other materials rise to the level of upper rim 664 of cooking vessel 606, rather than spitting them out into the immediate environment surrounding embodiment 601, downward directed rim 656, by interrupting the space between upper rim 664 of cooking vessel 606 and upper rim 686 of outer enclosure 604, blocks outward egress and forces all such materials into space 662 where they can be trapped in outer enclosure 604, which is liquid tight, for later disposal, and/or reuse, and/or for other purposes.

Control box/heat coil 608 has user operated latch 666 (FIG. 21), which prevents control box/heat coil 608 from being removed from outer enclosure 604 until user operated latch 666 is activated.

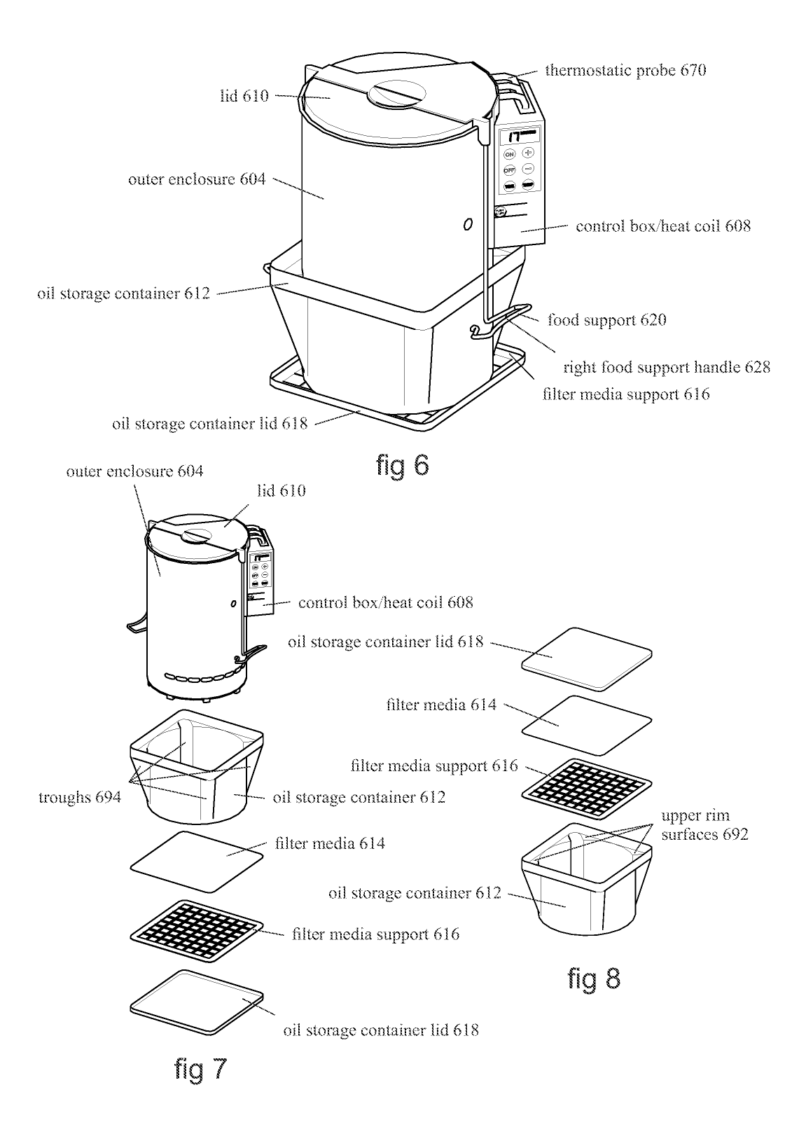

When oil is cooled down, the user may tip embodiment 601 forward toward 45° offset pouring rim 672 (FIGS. 19 and 20), and dump the oil within cooking vessel 606, for disposal, and/or storage, and/or reuse, and/or for other purposes, as a nonlimiting and nonexhaustive example, into oil storage container 612 (FIGS. 6, 7, and 8). Cold pins 668, and thermostatic probe 670, each are fixedly coupled to the top of control box 642 (FIG. 5), and loop over upper rim 664 of cooking vessel 606, thus they prevent it from sliding forward when embodiment 601 is tipped. This may happen until latch 666 is activated, and control box/heat coil 608 is removed from outer enclosure 604, which allows cooking vessel 606 to be removed from outer enclosure 604.

This arrangement of locking cooking vessel 606 inside of outer enclosure 604, allows simultaneous pouring of oil within cooking vessel 606 and oil, water, and/or debris, within outer enclosure 604, simply by tipping embodiment 601 forward. Thus it also helps prevent a user accidentally leaving oil, water, and/or debris in the bottom outer enclosure 604, after embodiment 601 has been used for cooking.

Openings 674 (FIG. 19), disposed most of the way around the base of outer enclosure 604, except below 45° offset pouring rim 672 (FIGS. 19 and 20), provide both an additional outlet for steam and/or exhaust beyond that provided by annular air gap 660, and openings 674 may also provide additional cooling for outer enclosure 604.

Referring to FIG. 24, as well as other figures herein, cooking vessel 606 is contoured to efficiently utilize cooking oil when cooking articles, including fowl, as well as other articles. Cooking vessel 606 is also configured to help minimize countertop space usage. To achieve these goals, cooking vessel 606's midriff tapers inward, such that its girth 680, measured 20% down from its upper rim 676 is shown as being 110% of its girth 682 measured 20% up from its base 678. This proportional relationship most advantageously accomplishes its goals with ratios above 105%. To help these goals still further, cooking vessel 606 is shown as having a height 684 which is roughly 145% of its width 686. This proportional relationship most advantageously accomplishes its goals with ratios above 130%. Utilization of displacement/cooking chamber 636, where appropriate, further helps to achieve the above goals of minimal countertop space utilization and reduced cooking oil usage.

Cooking vessel 606 is generally tubular, with an integral bottom. It's tubular cross-section may be of any suitable configuration, including polygon (triangular, square, diamond, pentagonal, hexagonal, etc.), irregular polygon, regular or irregular polygonal with rounded corners, regularly curved (such as circular, as shown, elliptical, etc.), any combination of the above for the top, middle, and/or lower portions of cooking vessel 606, or any other suitable configuration.

Embodiment 601 is most advantageously limited to 16 inches in overall height. This is because, in the US market, 16 inches is generally considered to be the minimal standard height for cabinets above kitchen countertop surfaces.

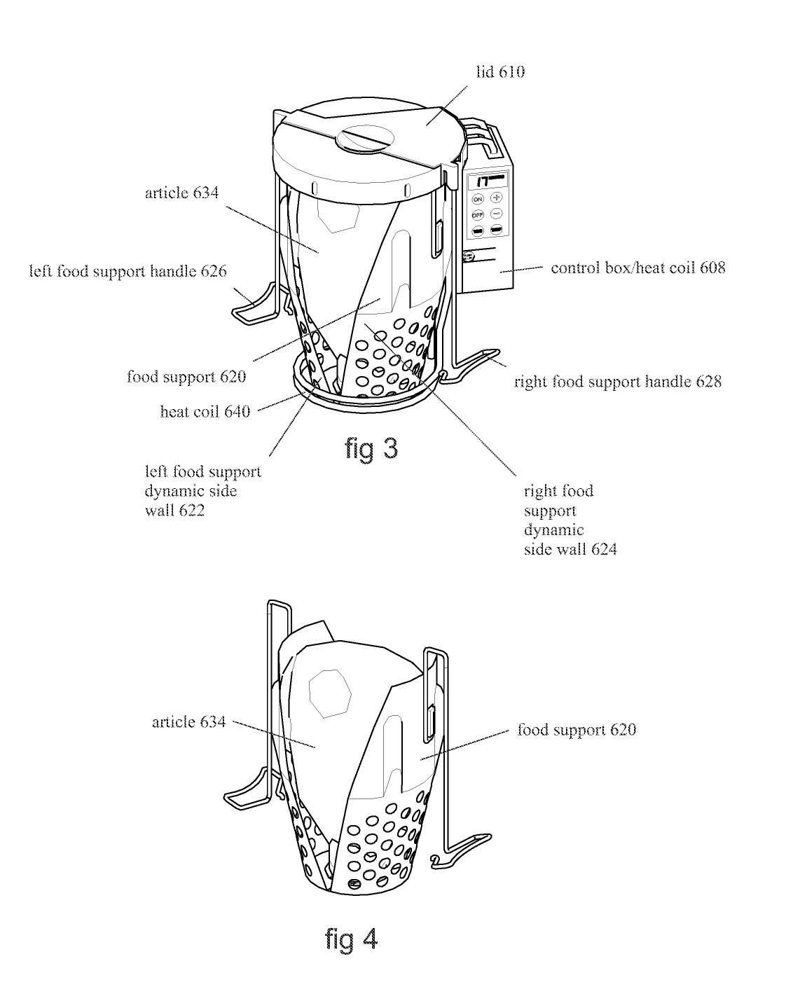

To help achieve this maximum height goal, as best shown in FIGS. 3 and 5, heat coil 640 is configured in a manner which disposes it in close proximity to outer lower outer wall 688, of cooking vessel 606, while leaving the center of heat coil 640 open, and thus not adding to the overall height of embodiment 601. As an example, article 634, disposed inside of food support 620, may be lowered directly on the floor of cooking vessel 606, instead of resting on, or being raised up by, a portion of a heat coil.

Cooking vessel 606 is supported by, and positioned within outer enclosure 604, by upper rim 664 of cooking vessel 606 being supported on its underside by cooking vessel mounting brackets 690, disposed on the upper interior of outer enclosure 604 (best shown in FIG. 5).

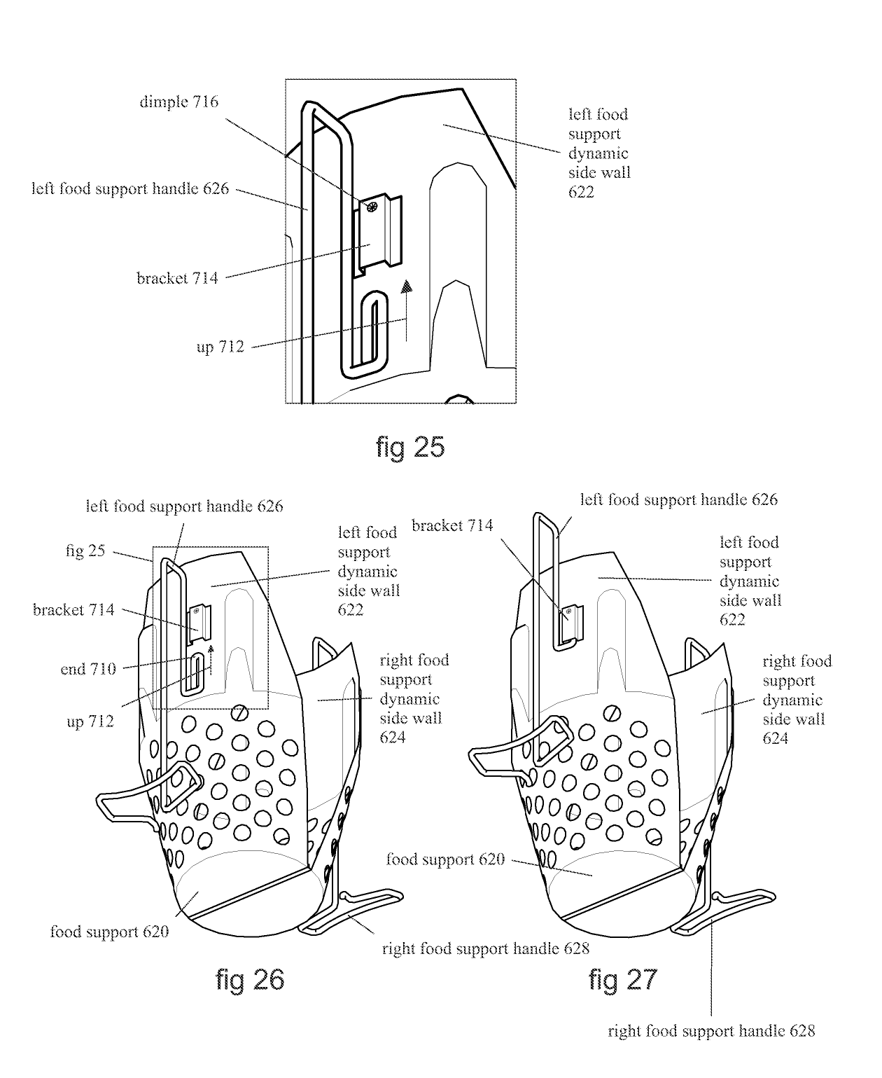

Left food support handle 626 and right food support handle 628 are detachable from left food support dynamic side wall 622 and right food support dynamic side wall 624 respectively, as best shown in FIGS. 25 through 27. As an example, mounting left food support handle 626 to left food support dynamic side wall 622 may be accomplished by pushing end 710 up 712 into bracket 714, where it is secured by both friction and by snap action caused by dimple 716 (FIG. 25). Detaching left food support handle 626 from left food support dynamic side wall 622 may be accomplished by striking the top of handle 626 downward. Detaching the handles may be desirable for shipping, storage, or for other purposes.

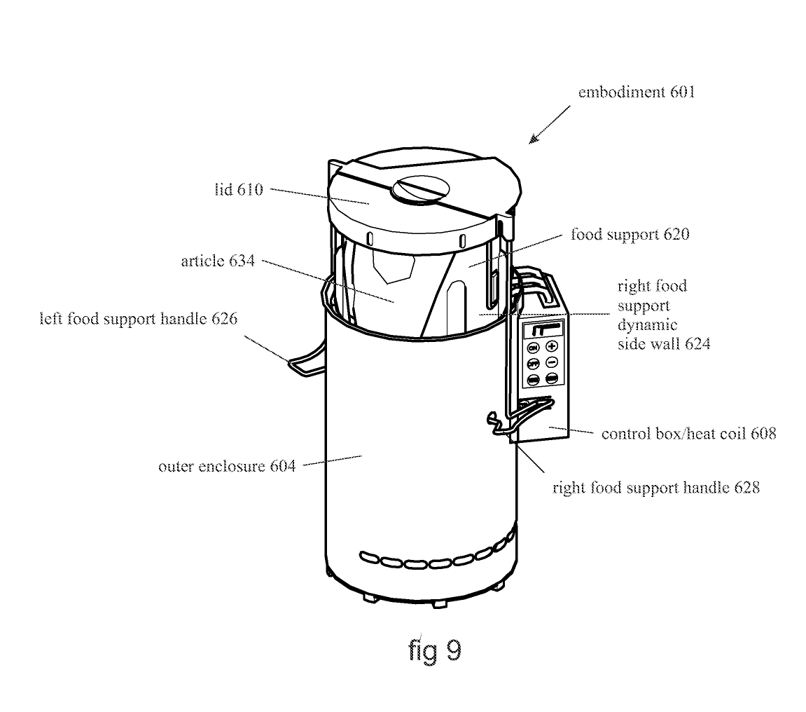

FIG. 9 illustrates how right food support handle 628 (and mirrored by left support handle 626) may hold food support 620 in a raised position above the oil level within cooking vessel 606, so that article 634 may be drained of cooking oil, or for other purposes, including, but not limited to, utilizing embodiment 601 for food steaming, by replacing cooking oil in cooking vessel 606 with water, and also potentially using wire basket 632 to hold articles to be steamed.

Oil storage, between uses, is a known problem for most food fryers, both, at least, because of inconvenience, and/or also because it may take up valuable countertop and/or refrigerator space.

For short durations, cooking oil may be left within embodiment 601, while, as a nonlimiting and non-exhaustive example, embodiment 601 remains resting on a countertop.

With extended periods between fryer uses, oil may be stored in its original container. In many cases, because of original container sizes, it may be difficult to store in a refrigerator, or on a countertop, or in a cabinet. In many cases also, pouring oil from the fryer back into the original container, may be difficult.

Further, oil ages and becomes unusable, at least partially because of charred particles within the oil and other contaminants. Filtering such particles and contaminants may make extended oil usage possible.

FIGS. 6, 7, and 8, address the directly above issues. Oil storage container 612 is configured to efficiently store within most refrigerators, and/or cabinets. Its square shape, and relatively shallow height aid in this efficiency.

Also, oil storage container 612, when not containing oil, may be stored by telescoping it over the bottom of embodiment 601 as shown in FIGS. 6, and 7. As also shown in FIGS. 6, and 7, oil storage container lid 618 filter media support 616, and optionally filter media 614 may be efficiently nested and stored below oil container 612.

Referring in particular to FIG. 8, filter media support 616, while disposed below and supporting filter media 614, may rest on upper rim surfaces 692, disposed on the upper portions of oil storage container 612 (FIG. 8). In this disposition, oil may be poured on to filter media 614 where the oil is filtered before entering oil container 612. As mentioned, this may help prolong the useful life of the oil.

Oil storage container lid 618 may be mounted to the top opening of oil storage container 612, to contain orders, promote freshness, and/or for other purposes. This may be done if filter media support 616 and optionally filter media 614 are mounted within oil storage container 612, or if they are ab sent.

Troughs 694 (FIG. 7) intended outward from the interior of oil storage container 612, aid in the easy pouring of liquids contained within oil storage container 612, as nonlimiting and nonexhaustive examples, back into its original container, for disposal, or back into cooking vessel 606 for cooking, and or for pouring liquids contained within storage container 612 elsewhere.

Troughs 694 may also provide convenient handholds during container movement, while pouring, or at other times.

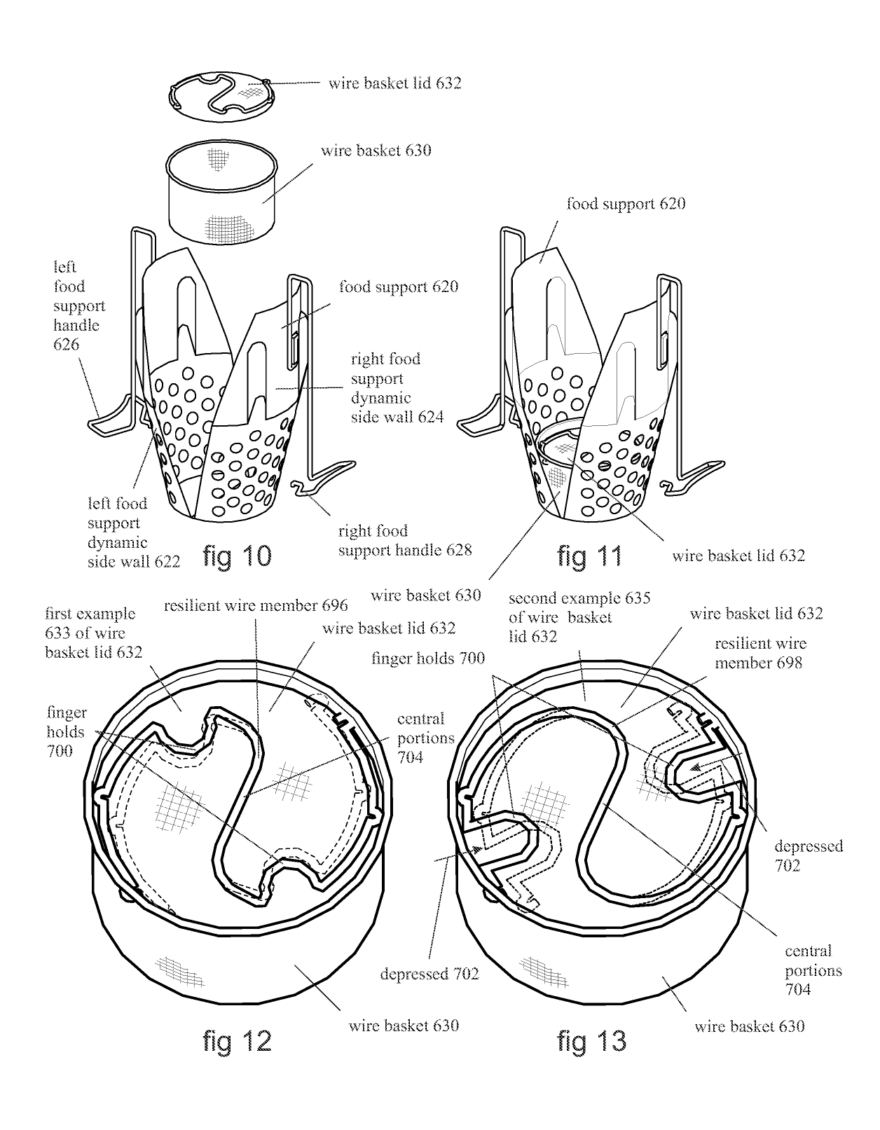

Embodiment 601, may be used to cook a broad variety of foods, including, but not limited to, those which are best deep fried in a fry basket. FIGS. 10 through 13 illustrate, as nonlimiting and nonexhaustive examples, screen and/or perforated metal, and/or sheet metal fry baskets which are compatible with use within food support 620 and cooking vessel 606. With the substitution of water for oil within cooking vessel 606, these fry baskets may be also adaptable for food steaming as well (FIG. 9).

Wire basket 630 may support within it, one or more wire basket lids 632, disposed horizontally flat, or at user directed angles, by resilient wire member 696, or resilient wire member 698, disengaging the side walls of wire basket 630 when finger holds 700 are depressed 702, and by re-engaging wire basket 630 when finger holds 700 are released, as shown in dotted lines in FIGS. 12 and 13. Using more than one wire basket lids 632, within wire basket 630, may allow stacking or layering of similar or dissimilar items, within wire basket 630.

Also, two or more wire basket 630s may be stacked within food support 624 during cooking.

As a non-limiting and nonexhaustive example, central portions 704 of resilient wire members 696 and 698 may be welded or otherwise fixedly coupled to the upper surface of wire basket 632.

Wire basket 630 and wire basket lids 634 and 636 are configured for convenient one hand operation.

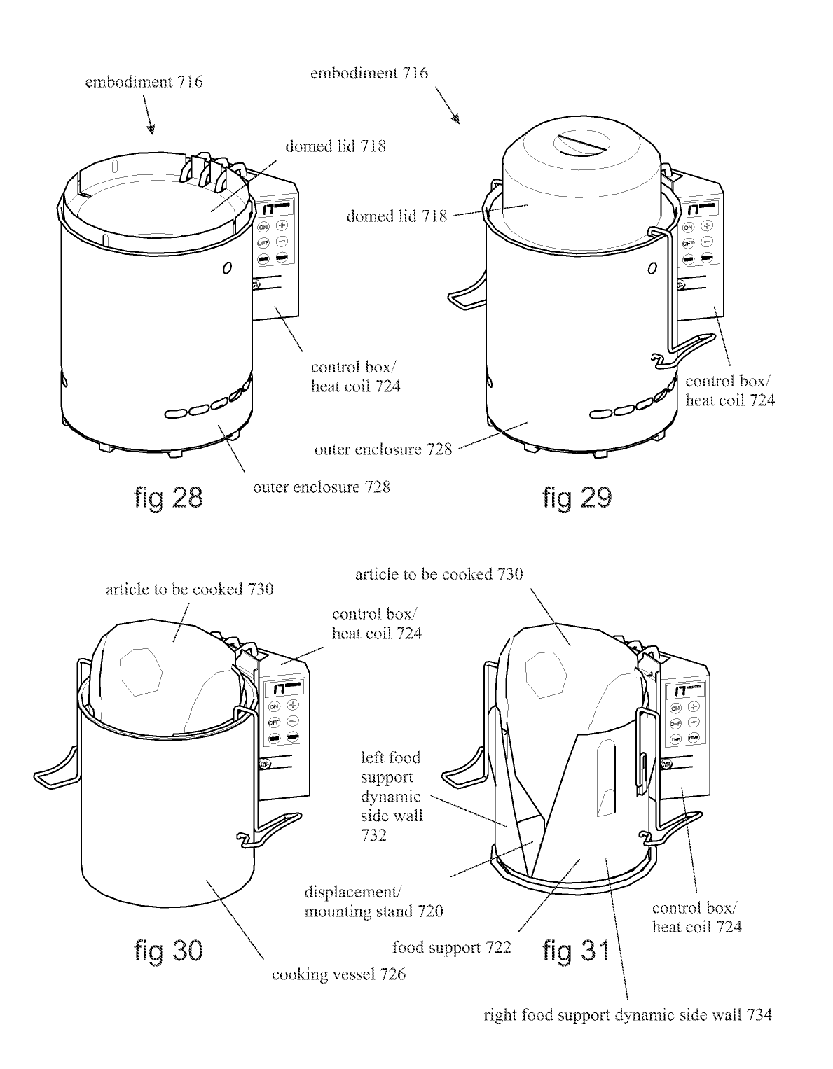

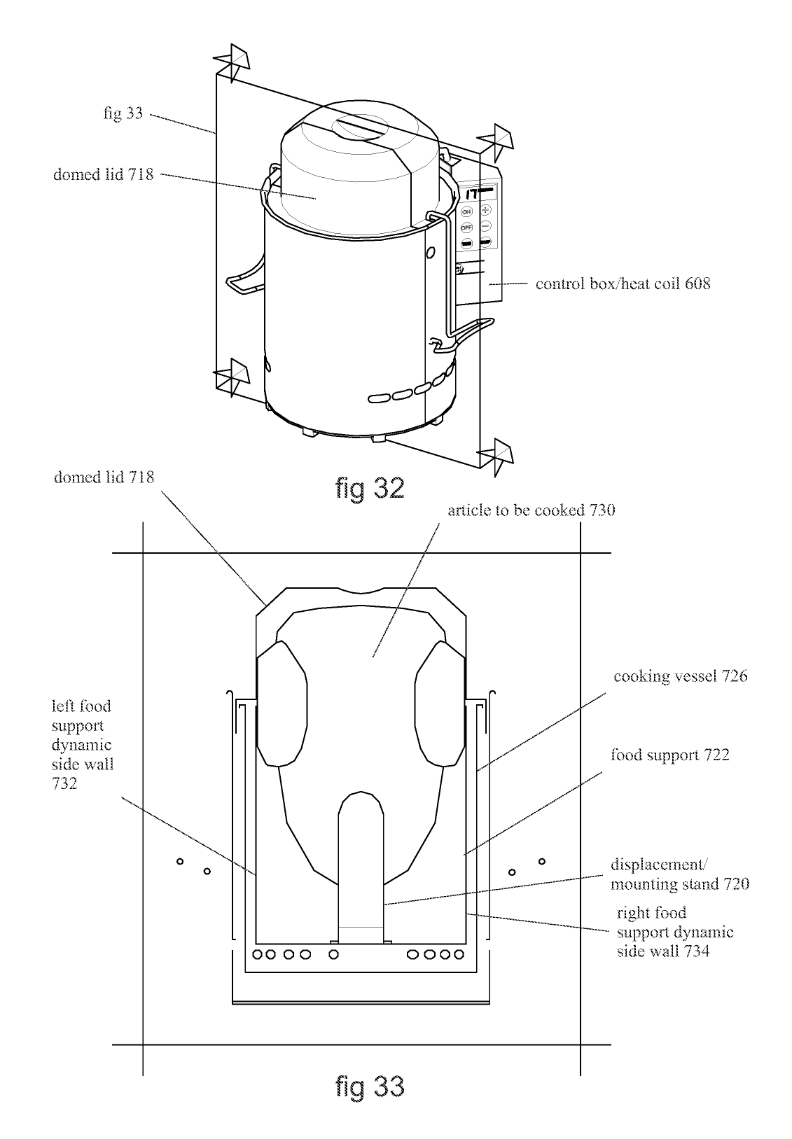

Detailed Description—Embodiment 716—FIGS. 28 through 34:

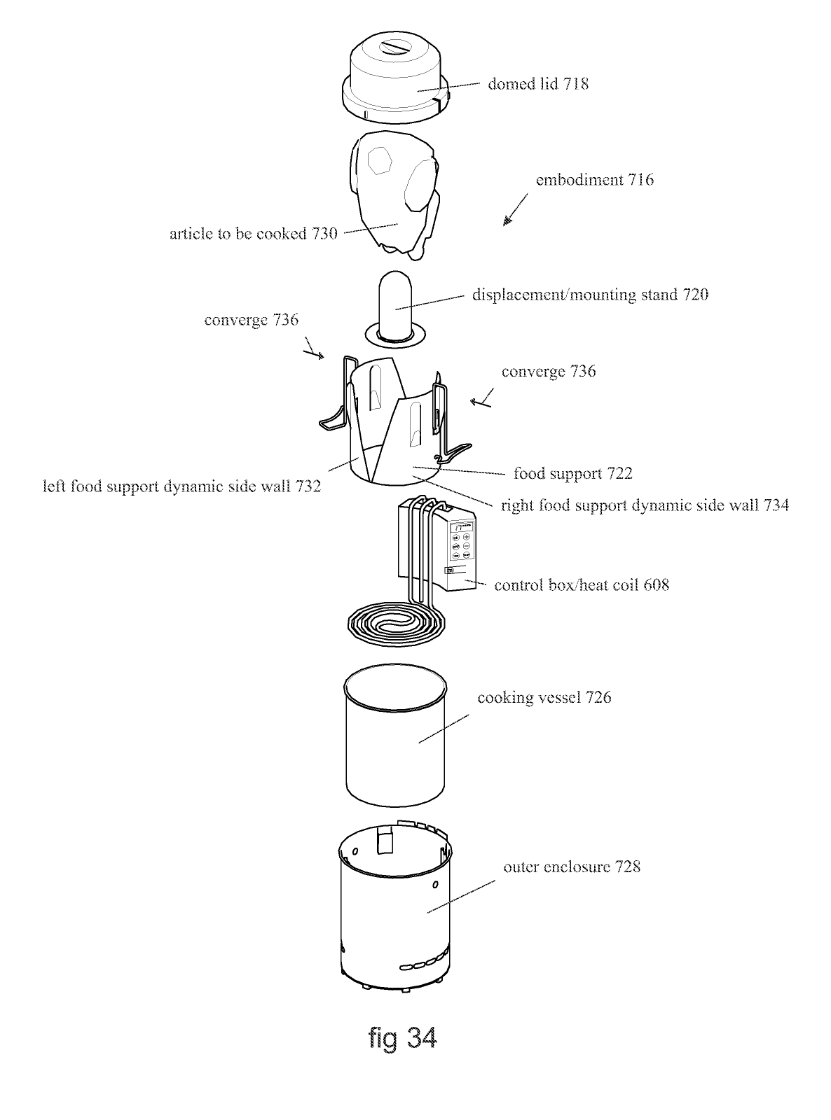

Referring especially to FIG. 34, as well as to other figures herein, embodiment 716, as apparent, shares many construction details with embodiment 601. Embodiment 716 Is generally comprised of: domed lid 718, displacement/mounting stand 720, food support 722, cooking vessel 726, and outer enclosure 728.

Embodiment 716 may be used, as a nonlimiting and nonexhaustive example, to cook articles using a two-step immersion process, as described in U.S. Pat. No. 8,309,151, claims 1 and 6, FIGS. 142 to 145.

Generally speaking, and as a nonlimiting and nonexhaustive example, a user cooking an article within embodiment 716 may employ the following steps:
Placing Cooking Vessel 726 within outer enclosure 728.
Mounting control box heat coil 608.
Filling cooking vessel 726 with a predetermined amount of cooking liquid,
Activating control box/he coil 608 to heat the cooking liquid.
Mounting article to be cooked 730 within food support 722. As a nonlimiting and nonexhaustive example, if article to be cooked 730 is a fowl, and if the fowl is being mounted in a breast up position, as shown in FIG. 34, placing displacement/mounting stand 720 within the empty gut cavity of the fowl. and placing the assembly on the floor of food support 722, causing left food support dynamic side wall 732, and right food support dynamic side wall 734 to converge 736 toward one another, analogous to transition from FIG. 16 to FIG. 17. Or, if the fowl is being mounted in a breast down position for the first immersion into the cooking liquid, simply placing the fowl within food support 722 in a breast down position, with or without mounting displacement/mounting stand 720 being inserted into the fowl.
Placing domed lid 718 on top of article to be cooked 730 and immersing the assembly, except for domed lid 718, in the hot cooking liquid long enough for the fowl to be cooked.
Removing the fowl from the cooking liquid and inverting it.
Placing domed lid 718 on top of article to be cooked 730, and immersing the fowl back in the cooking liquid long enough for the fowl to be cooked an additional time.
Removing the fowl from the cooking liquid and serving it. Again, displacement/mounting stand 720 may be used as a carving stand during serving.

1. A device to fry articles comprising:
a cooking vessel configured to hold frying liquid and food being fried; and
a heat source configured to heat, to frying temperatures, liquid and food being fried within the cooking vessel, the cooking vessel having a height which is 130% or more of its width;
wherein the cooking vessel has a girth, measured 20% down of the vessel's height from the vessel's upper rim, which is 105% or more greater than the cooking vessel's girth measured 20% up, of the cooking vessel's height, from the cooking vessel's floor.

2. The device of claim 1 further configured to receive a whole fowl in a vertical, breast up, legs down, disposition.

3. The device of claim 2 further including a member disposed within a gut cavity of an associated whole fowl contained within the cooking vessel, the member displacing volume within the gut cavity which would otherwise be occupied by frying liquid.

4. The device of claim 3 further including the member disposed in a downward opening, liquid tight vessel.

5. The device of claim 4 further including a cap configured to selectively cover the vessel's downward opening.

6. The device of claim 5 further including a one-way valve disposed in a vessel wall so as to allow fluid to exit, but not reenter, the vessel.

7. A device to fry articles comprising:
a cooking vessel configured to hold frying liquid and food disposed in the frying liquid;
a heat source configured to heat the food and frying liquid to a frying temperature;
a cooking liquid volume displacement member configured to be disposed within food being within the cooking vessel during a frying operation, the cooking liquid volume displacement member displacing volume which would otherwise be occupied by frying liquid.

8. The device of claim 7 further including the cooking liquid volume displacement member comprised of a downward opening, liquid tight vessel.

9. The device of claim 8 further including a cap configured to cover the vessel's downward opening during a frying operation.

10. The device of claim 9 further including a one-way valve disposed in a vessel wall which allows fluid to exit, but not reenter, the vessel.

11. The device of claim 7 wherein the cooking liquid volume displacement member is configured to hold food to be cooked when frying is taking place.

12. A device to fry articles comprising:
a cooking vessel configured to hold frying liquid and associated food disposed therein;
a heat source configured to heat the frying liquid and food to a frying temperature;
first and second plates configured cooperatively to move toward and away from one another;
the first and second plates disposed within the cooking vessel so as to contain between them food being fried.

13. The device of claim 12 wherein the first moving plate is connected to the second moving plate through a rotary joint.

14. The device of claim 12 wherein the first moving plate is spring biased to move away from the second moving plate.

15. The device of claim 12 wherein the first moving plate and the second moving plate are coated with nonstick material.

16. The device of claim 12 further including the first moving plate having a first handle and the second moving plate having a second handle.

17. The device of claim 16 further including a lid configured to selectively cap the cooking vessel, the lid being coupled to uppermost portions of both the first handle and the second handle, while frying of food is occurring.

18. The device of claim 17 wherein when the lid is coupled to uppermost portions of both first and second handles, the first moving plate and the second moving plate are secured in predetermined dispositions.

19. The device of claim 18 wherein the first handle is user detachable from the first moving side plate.

20. The device of claim 12 wherein the cooking vessel includes a side wall, and the first moving plate includes a spacer member on its exterior surface, the spacer member being configured to dispose the first moving plate at a predetermined distance away from the cooking vessel side wall during frying.

21. The device of claim 12 further including a fluid permeable food containment vessel configured to be disposed between the first moving plate and the second moving plate during frying.

22. The device of claim 21 further including a fluid permeable lid configured to cap the fluid permeable food containment vessel during frying.

23. A device to fry articles comprising:
a cooking vessel configured to hold frying liquid and associated food disposed therein, the cooking vessel having an cooking vessel upper rim;
a heat source, configured to heat the frying liquid and food to frying temperatures;
an outer enclosure having an outer enclosure upper rim configured to contain the cooking vessel;
a lid configured to selectively cover an opening of the cooking vessel, the lid having a descending, generally vertical side wall disposed intermediate of the cooking vessel upper rim and the outer enclosure upper rim when the lid covers the cooking vessel opening.

24. The device of claim 23 wherein the downward descending, generally vertical side wall and the upper rim of the cooking vessel define a predetermined gap.

25. The device of claim 24 further comprising a fluid retaining holding basin in fluid communication with the first predetermined gap.

26. The device of claim 23 wherein the descending generally vertical side wall and the upper rim of the outer enclosure define a second predetermined gap.

27. The device of claim 23 wherein outer enclosure includes a plurality of openings.

28. A device to fry articles comprising:
a cooking vessel having an upper rim configured to hold frying liquid and associated food disposed therein;
a heat source configured to heat the frying liquid and food to a frying temperature;
an outer enclosure configured to contain the cooking vessel;
an open top vessel configured to hold the cooking liquid and to telescope over and contain the base of the outer enclosure; and
a lid configured to cap the open top vessel.

29. The device of claim 27 further including a filter configured to filter liquid passing into the open top vessel.

30. The device of claim 27 further including the open top vessel having a pour spout.

31. A device to fry articles comprising:
a cooking vessel having an upper room, the vessel configured to hold frying liquid and associated food disposed therein;
a heat source, configured to heat the frying liquid and food to frying temperatures;
a fluid permeable food containment vessel, having generally vertical side walls, the containment vessel configured to be immersed in the frying liquid;
a fluid permeable lid configured to selectively cap the fluid permeable food containment vessel;
a generally S-shaped, elongated member with a central portion fixedly coupled to the fluid permeable lid, the generally S-shaped elongated member configured, to selectively engage the generally vertical side walls of the fluid permeable food containment vessel under finger pressure.

32. A device to fry articles comprising:
a cooking vessel including a floor, the cooking vessel configured to hold frying liquid and associated food disposed therein;
a heat source, configured to heat the frying liquid and food to frying temperatures;
the heat source comprising an electrically energized tubular element with an open center is disposed within the cooking vessel; and
a food support, disposed within the cooking vessel so as to secure to electrically energized tubular element with an open center of the cooking vessel.

33. The device of claim 31 further including the cooking vessel having a side wall projecting generally vertically up from the perimeter of the floor and wherein the electrically energized tubular element is proximate to the side wall.
